(19) United States
(12) Patent Application Publication
(10) Pub. No.: US 2006/0156846 A1
(43) Pub. Date: Jul. 20, 2006

(54) Actuator drive mechanism with limited actuating path and emergency disconnect

(76) Inventors: Achim Neubauer, Sinzheim-Vormberg (DE); Joerg Aschoff, Buehl (DE); Werner Dilger, Buehl (DE); Rolf Pierenkemper, Buehlertal (DE); Martin-Peter Bolz, Buehl (DE)

Correspondence Address: STRIKER, STRIKER & STENBY, 103 East Neck Road, Huntington, NY, 11743, US

(21) Appl. No.: 11/260,603

(22) Filed: Oct. 27, 2005

Related U.S. Application Data
(63) Continuation-in-part of application No. 10/343,364, filed on Jan. 30, 2003, now abandoned.

(30) Foreign Application Priority Data
Feb. 5, 2001 (DE) 101 05 032.1

(51) Int. Cl. F16H 1/16

(52) U.S. Cl. 74/425

(57) ABSTRACT

The present invention relates to an actuator drive mechanism with a control motor (1), which on the power takeoff side drives a control gear that includes a final control element (3) on the drive side and a final control element (5) on the power takeoff side. The final control element (5) on the power takeoff side cooperates with an adjusting element (11), by way of which engines or machines can be varied in their operating behavior. Associated with the final control element (3, 5) on the drive side or the power takeoff side is a power takeoff component (8), which includes a force-transmission-free region (25), and on which a spring element (21) is received movably within a recess (19).

### CROSS REFERENCE TO A RELATED APPLICATION

This application is a Continuation-in-Part of patent application Ser. No. 10/343,364 filed on Jan. 30, 2003.

### BACKGROUND OF THE INVENTION

In actuator drive mechanisms in use today to actuate couplings or gears, electric motors are typically used. A worm, for instance, is formed onto their armature shaft. This worm cooperates with a worm wheel and optionally other gear stages provided. In some applications it is required that, if there is a power failure at the actuator-drive mechanism, that drives a worm drive, a displacement is necessary and must be performed. In these cases the worm has to be driven by the worm wheel. Therefore, the worm drive must not be self-inhibiting.

The vehicles that are driven with internal combustion engines, whether they are utility vehicles or passenger cars, exhaust gas turbochargers can be used, so that during the intake stroke of the engine better filling of the individual cylinders of the engine with gas can be achieved, whether the engine is a direct-injection type or a mixture-compressing engine with externally supplied ignition. If exhaust gas turbochargers are displaced via an electric motor, which comprises a worm drive with a worm and a worm wheel, and/or are provided with a rack and pinion assembly, then on the power takeoff side, not only a linear but a rotary motion can be generated by way of which the guide blade rings of an access gas turbocharger can be displaced and its operating behaviour and effectiveness can be varied. A power failure at the actuator drive mechanism is a major problem, since even if there is a power failure, a displacement at the exhaust gas turbocharger, to name one example, must be assured. Thus, an exhaust gas turbocharger with a variable turbine geometry, that is actuatable by means of an electric actuator drive mechanism, in the closed guide vane position, which in this state allows the passage of a flow of exhaust gas, must be capable of being opened again quickly if there is a power failure at the actuator drive mechanism associated with. Fast opening of the guide blade ring is required if, for an engine whose exhaust system contains the exhaust gas turbocharger, the driver suddenly “steps on the gas”. In this state, however, the flow of exhaust gas, which expands as it flows through the exhaust turbine, but when the guide blade ring is closed, is prevented from passing through the flow machine at the exhaust gas turbo charger, could cause considerable damage.

With actuator drive mechanisms in use today, it is extremely difficult to react to a power failure at an actuator drive mechanism.

### SUMMARY OF THE INVENTION

The embodiment proposed according to the invention does not permit any transmission of force to the final control element in one control region of the actuator drive mechanism. A final control element that functions when, without current is provided, which, if there is a power failure, assures a residual displaceability. This can be achieved by making modifications in actuator drive mechanisms in present used; with the embodiment proposed according to the invention, if there is a power failure, the “open” state can be brought about quickly at the final control element to be actuated, since only short flotation paths have to be traversed. With the arrangement proposed according to the invention, a spring can be connected parallel to a drive mechanism, reinforcing the drive of the final control element; for instance, together with an electric motor, the guide blade ring of a turbo charger can be kept closed during breaking.

The disconnection of adjusting elements from final control elements, as proposed according to the invention, allows the same parts to continue to be used in driving components, since only slight modifications have to be made in known drive motors in present use, which advantageously means that retrofitting costs are saved.

The embodiment proposed according to the invention permits a disconnection of final control elements over the entire path of rotation of a final control element. The restoring effect is thus assured by the spring element, provided parallel to the actuator drive mechanism, referred to one complete revolution of the affected final control element, both before the reversal of the tension direction and after the reversal of the tension direction of the spring element, during the rotation of the final control element. This is attained by providing that the spring element is retained movably via a pin guided in a groove of the final control element and is supported by its other end at a fixed, but rotatable point. In normal operation, in which an adjusting element acted upon by the final control element is moved back and forth between two positions, the spring is always taut. Upon the revolution of the final control element, the pivot point of the spring element, which point is guided movably in the final control element, is displaced, so that after a half-revolution of the final control element a maximum tension exists in the spring element. If in this rotary position the current at the drive motor failures should fail, then the energy of the spring element stored in the spring element moves the final control element into a position in which it is disengaged from the adjusting element, for example by way of an interruption in an external toothing.

If the current at the actuator drive mechanism fails before the reversal of force of the spring element, then the adjusting element can be moved automatically into the “open” position by the spring element and the load. In that case, an overrotation of the final control element into the zone without force transmission is unnecessary.

In a further variant embodiment of the concept on which the invention is based, instead of adapted spring elements, an electromagnetic coupling and decoupling, or connection and disconnection can also be achieved.

### BRIEF DESCRIPTION OF THE DRAWINGS

The invention is described in further detail below in conjunction with the drawing.

Shown are:

FIG. 1, the schematical layout of a conventional actuator drive mechanism with a worm gear, rack and pinion;

FIGS. 2.1 through 2.4, a schematic illustration of the disconnection principle of a rack and pinion assembly, in which the pinion is received coaxially to worm wheel;

FIG. 3, an illustration of the superposition of the courses of the force of the spring element, the fictive load and the resultant load for the actuator drive mechanism; and

FIG. 4, the basic layout of an electromagnetic spring system for the emergency disconnect in the state with and without current.

### DESCRIPTION OF THE PREFERRED EMBODIMENTS

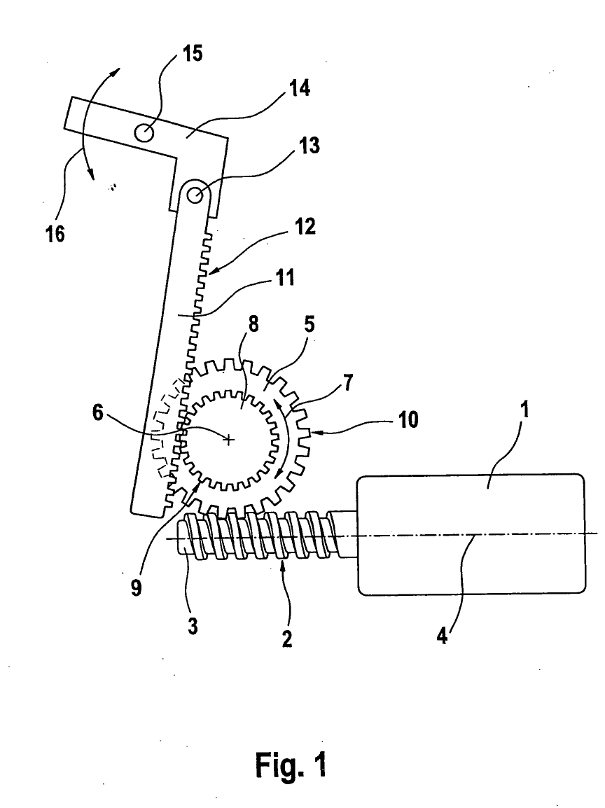

From the view in FIG. 1, the schematic layout of a conventional actuator drive mechanism with a worm gear, rack and pinion is seen in further detail.

In this view of an actuator drive mechanism of a typical type today, with a control motor 1 and a worm gear 3, 5 and an adjusting element 11 in the form of a rack, the control motor 1 drives the worm gear 3, 5. The armature shaft 2 of the control motor 1, which coincides with the line of symmetry 4 of the control motor, is provided with a worm thread, which cooperates with an external toothing 10 on the worm wheel 5. The rotary axis 6 of the worm wheel 5 extends perpendicular to the plane of the drawing; that is, the worm wheel 5 and worm 3 are oriented at a right angle to one another. A power takeoff component 8 in the form of a pinion with external teeth is provided coaxially and rigidly relative to the worm wheel 5. Depending on the direction of rotation of the control motor 1, a motion of the worm wheel 5 in one of the directions, represented by the double arrow 7, is initiated via the established direction of rotation. The power takeoff component 8, with its external toothing 9, cooperates with a rack 1 1, which in the view of FIG. 1 acts as an adjusting element. The rack 11 is provided with teeth 12 on its side oriented toward the power takeoff component 8. The rack functioning as an adjusting element 11 is received rotatably, on its upper end 13, on an L-shaped lever 14. The lever is in turn movable about a pivot shaft 15. The pivoting direction is represented by the double arrow, which is identified by reference numeral 16.

With the arrangement that is schematically shown in FIG. 1, a linear motion can be generated, in accordance with the vertical up-and-down motion of the rack 1 functioning as an adjusting element, as represented by the double arrow 16. Instead of a linear motion, a rotary motion can also be brought about by means of an adjusting element 11. In these typical adjusters, if there is a power failure at the control motor 1, a displacement is possible only with relatively high forces, if at all. This has the disadvantage that for numerous potential applications, an actuator drive mechanism of this kind represents a major problem in performing a displacement at the adjusting element 1 1 in the event of a power failure. This can become critical, particularly whenever, in machines such as exhaust gas turbochargers that are located in the exhaust system of an internal combustion engine with greatly fluctuating operating states (these are known as VTG chargers), displacements of the guide blade ring, for instance from the closed to the open state, have to be made when there is a power failure. In an exhaust gas turbocharger of variable turbine geometry, for instance, it can be urgently necessary to open a closed guide blade ring if the driver suddenly “steps on the gas”, to protect this machine in the exhaust system of an internal combustion engine from damage.

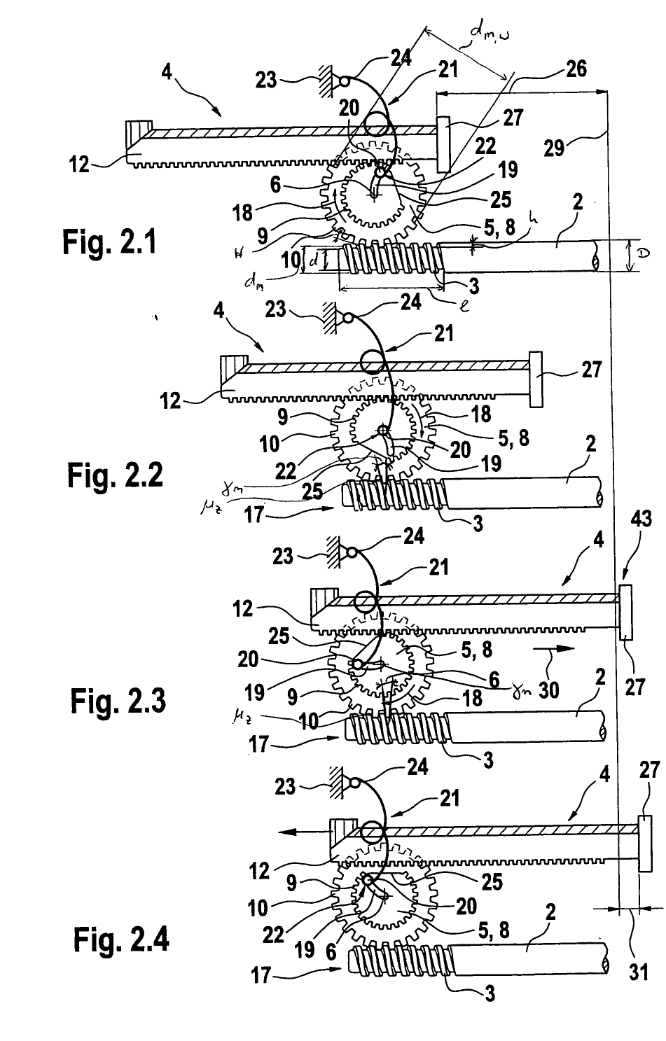

From the drawing cycle shown in FIGS. 2.1 through 2.4, a schematic illustration of a disconnection principle, proposed according to the invention, for a rack and pinion assembly can be seen in more detail; the pinion with external toothing that functions as the power takeoff component is received coaxially to the worm wheel.

In the view given in FIG. 2.1, the thread 17 of a worm 3 is embodied on an armature shaft 2 of a control motor 1, not given in greater detail in FIG. 2.1. This thread 17 meshes with a male thread 10 of a worm wheel 5 that rotates about a rotary axis 6. A power takeoff component 8 is shown coaxially to the worm wheel 5 of the worm gear 3, 5; in the view given in FIG. 2.1, it is embodied as a pinion with teeth on the outside, its external toothing 9 being interrupted in one region 25. In the view of FIG. 2.1, a recess 19 in the form of a longitudinal groove is let into the pinion 8 with external teeth that serves as the power takeoff component. One boundary of the recess 19 coincides with the rotary axis 6 of the worm wheel 5 and power takeoff component 8, while the outer boundary of the recess 19 in the form of a longitudinal groove, which recess may be embodied in the worm wheel 5 or in the power takeoff component 8, ends below the external toothing 9.

Above an adjusting element 11, such as a rack provided with an external toothing 12, a spring element 21 is suspended from a fixed bearing 23 in a stationary articulation 24. The spring element 21 may for example be embodied as a wrap spring, a spiral spring, or the like, which with its end opposite the fixed bearing 23 is supported in a movable pivot point 22, in the form of a pin 20 guided in the recess 19.

The rack functioning as an adjusting element 11 is provided with a stop 27, which in the view of FIG. 2.1 is located at a distance, located at reference numeral 26, from a reference position 29. On the end opposite the stop 27 of the rack that acts as an adjusting element 11, there is a chamber. In the view in FIG. 2.1, the adjusting element 11 is in its first extreme position 42, which can for example be the position in which, in an exhaust gas turbocharger of variable turbine geometry contained in the exhaust system of an internal combustion engine, the guide blade ring is placed in its open position. When current is being supplied to the control motor 1, or in other words in the normal operating mode, the spring element 21 is relatively only slightly tensioned.

In FIG. 2.2, as a result of the rotations of the armature shaft 2 with the worm gear received on it, which gear meshes with the worm teeth 10 of the worm wheel 5, the pinion 8 with external teeth that functions as the power takeoff component has rotated onward in the direction of rotation 18 by a good quarter-revolution. During this quarter-rotation, the stop 27 of the rack, provided with a toothing 12 and functioning as an adjusting element 11, has moved toward the reference edge 29. During this quarter-rotation, the external toothing 9 of the externally toothed pinion acting as the power takeoff component and the teeth 12 of the racklike adjusting element 11 mesh with one another. During this quarter-rotation described in FIG. 2.2, the recess 19, whether it is embodied in the power takeoff component 8 or in the worm wheel 5, has rotated accordingly, and the spring element 21, for instance configured as a wrap spring, is slowly tensioned further. During this partial rotation, the pin 20, which is guided movably in the recess 19 and acts as the movable articulation 22 of the spring element 21, has moved in the recess 19 in the direction of the rotary axis 6 of the worm wheel 5 or of the power takeoff component 8, so that no later than approximately a half-revolution of the worm wheel 5 or of the power takeoff component 8, the spring element is tensioned maximally. This course of motion has the advantage that upon further rotation, until reaching the second extreme position 43 (see FIG. 2.3), the spring element 21 of the rack functioning as the adjusting element 11 has reinforced the control motor somewhat, which can for instance be utilized so that in this position, the spring element 21 together with the control motor 1 keeps a guide blade ring of an exhaust gas turbocharger closed during braking. Upon reverse rotation out of the position shown in FIG. 2.2, the spring element would relax again, and the pin 20 would move back again in the groove 19.

From FIG. 2.3, it can be seen that the stop 27 of the adjusting element 11 has moved outward to beyond the reference edge 29; that is, the adjusting element 11 has assumed its second extreme position 43, in the view shown in FIG. 2.3, the teeth 12, mounted on the outside of the adjusting element 11, and the external toothing 9 of the pinion 8 acting as a power takeoff component still just barely mesh. In this extreme position 43 given in FIG. 2.3, if the current at the control motor 1—the latter not given in greater detail here—fails, then the spring element, by its prestressing, brings about an overrotation of the worm wheel 5, or of the pinion 8 with external teeth, in such a way that the pinion 8 or worm wheel 5 is overrotated to such an extent that no further engagement of teeth occurs between the external toothing 9 of the power takeoff component 8 and the teeth 12 of the adjusting element 11. This is accomplished by further rotation of the power takeoff component 8 or worm wheel 5 in the direction of rotation 18, so that the region 25 of the power takeoff component that has no teeth is located below the external toothing 12 of the racklike adjusting element 11. As a result, the adjusting element 11 becomes freely movable relative to the power takeoff component 8 or to the worm wheel 5.

In FIG. 2.4, it is shown that the racklike adjusting element 11 is freely movable relative to the power takeoff component 8 or the worm wheel 5. The stop 27 of the adjusting element 11 has moved past the reference edge 29 by a distance 31, in which there is no longer any tooth engagement, that is, force transmission, between the adjusting element 11 of the power takeoff component 8 and the worm wheel 5. In this state, the chamber embodied on the adjusting element 11 runs up onto a winding of the wrap spring 21, so that the rack 11, which is disengaged, is moved out of its second extreme position 43 back in the direction of its first extreme position 42, as represented by the arrow shown at the chamfer in FIG. 2.4. This is accomplished as a result of the fact that the wrap spring 21, pivotably connected at the stationary fixed bearing 23 and movably guided in the recess 19, is not yet completely relaxed and still has a residual tensing force.

The residual spring force that the spring element 21, embodied for instance as a wrap spring, still has no longer suffices to rotate the worm wheel 5 or power takeoff component 8 onward counter to the detent moment of the control motor 1 and the losses that occur in the worm drive 3, 5, and so the gear stays in the position shown in FIG. 2.4, and the rack functioning as the adjusting element 11 can be moved freely for instance by means of the blade forces in the guide blade ring that occur in the exhaust gas turbocharger. The worm gear 3, 5 is designed in terms of its tooth geometries such that no self-inhibition occurs.

For worm gears 3, 5 like for each other gear, self-inhibition is a function of efficiency. The worm gear 3, 5 is not self-inhibiting if the efficiency is equal or greater than 50%. The efficiency of worm gears 3, 5 depends on friction factor and lead angle at the penetration of the toothing γₘ. The calculation of the efficiency is as follows:
η_{z}=tanγₘ/tan(γₘ+ρ_{z})
with the efficiency η_{z}, the average lead angle at the penetration of the toothing γₘ and the friction angle ρ_{z}. The friction angle ρ_{z} is a finction of the tooth friction factor μ_{z} and is calculated by tan(ρ_{z})=μ_{z} . As long as the value of the efficiency η_{z} is greater than 0.5 the worm gear 3, 5 is not self-inhibiting. This means, that the worm wheel 5 can be driven by the worm 3. The friction factor μ_{z} depends on the material of the worm 3 and the worm wheel 5 and—if a lubricant is used—also on the lubricant. The value of the friction factor μ_{z} is generally in the range from 0.01 to 0.2 but may even be smaller than 0.01. The friction factor can be determined as described in Maschinenelemente, Vol. III, Springer-Verlag, 2^{nd} edition, 1986, pages 82, 83.

The following is only an example for an average lead angle at which the efficiency is bigger than 0.5 which means that the worm gear is not self-inhibiting and does not delimit the invention to the mentioned values.

If for example the angle γₘ is chosen as being 6°, and the friction factor μ_{z} is chosen to be 0.1 depending on the surface roughness of the material chosen, according to the equation η_{z} =tan γₘ/(tanγₘ−92 _{z}) an efficiency of 0.51327 is calculated, i.e. in this case the worm gear is not self-inhibiting.

Preferred materials for the worm 3 are for example CuSn-bronze, Al-bronze, or brass, but cast iron or steel is also applicable as material for the worm 3. Particularly, the worm is made of steel or bronze. Particularly for small worms 3 also plastics is suitable. Preferred materials for the worm wheel 5 are plastics, such as POM (polyoxymethylene) or PA (polyamide). However, the worm wheel 5 can also be made of CuSn-bronze, Al-bronze, brass, cast iron or steel. If the worm is made of steel, it has turned out that tempered and grinded worms 3 are more advantageous than quenched and tempered and milled worms 3. Concerning the lubricants, synthetic oils are more suitable than mineral oils, particularly regarding the running-in characteristics. Concerning the manufacturing of the thread pitch of the worm 3, big pitches are preferred. The worms can either be multiple-threaded or single-threaded. Regarding the deflection, single-threaded worms 3 having a bigger diameter d of the shaft 3.1 behave more suitable than single-threaded worms 3 having a smaller diameter d of the shaft 3.1. The length 1 of the worm 3 is selected in such a way that no or nearly no deflection occurs. If a deflection in case of the load on the worm 3 would occur, a worm 3 with a shaft 3.1 of bigger diameter d could be chosen or a supporting bearing can be used to support the worm 3. The ratio of the length 1 to the outer diameter D of the worm 3 is for example within the range from 1.5 to 3. Depending on the design of the worm gear 3, 5 also smaller or bigger ratios of length 1 to outer diameter D are suitable, as long as no or nearly no deflection occurs.

The diameter d of the shaft 3.1 of the worm 3 is chosen depending on the use of the worm gear 3, 5. Preferably, the shaft of the worm 3 has a diameter d of 4 to 8 mm. But in case of micro-drives also diameters d of the shaft being for example 1 mm or smaller are possible. In case of bigger actuators also diameters d being bigger than 8 mm are possible.

The height of the flank h of the worm 3 depends on the tooth height H of the worm wheel 5 and the purpose the worm gear 3, 5 is used for. The height of the flank h of the worm 3 can take each value up to the half diameter of the core.

The ratio of the diameter dₘ of the worm 3 to the diameter d_{m,w} of the worm wheel 5 based on the reference circle is preferably within the range from 1:3 to 1:7.

In each of FIGS. 2.1 to 2.4 the initial position and the end position of the adjusting element 11 are shown in dash-dot-dot- lines.

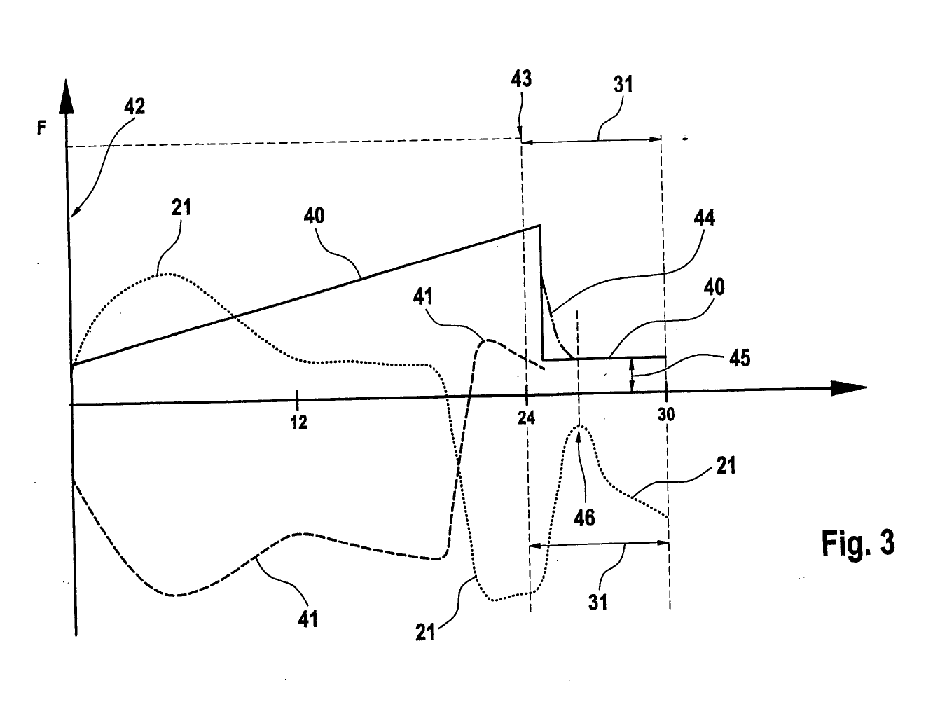

FIG. 3 shows a view illustrating the superposition of the courses of the force of the spring element, a fictive load, and the resultant load for the actuator drive mechanism, plotted over the travel distance.

As can be derived from FIG. 3, the spring element 21 is already taut in the first extreme position 42, which corresponds to the open position of the rack functioning as the adjusting element 11, and thus the control motor 1 has to work counter to the spring force and to the fictive load 40. If a motion of the power takeoff component 8 or worm wheel 5 or rack 11 in the direction of the second extreme position 43, which is equivalent to a closed position, now takes place, then the load increases virtually linearly, as represented by the curve course 40, and the spring element is tensioned further; that is, the spring force acting counter to the control motor 1 still further increases. As a result of the rotation of the power takeoff component 8, in the form of a pinion with external teeth, the angle of the spring element relative to the rack functioning as the adjusting element 11 changes, and the pin 20, by way of which the spring element 21 is connected to the power takeoff component 8, migrates inward in the groovelike recess 19. As a consequence, with increasing travel of the adjusting element 11 in the direction of the second extreme position 43, the spring force decreases again beyond a certain point, and then remains virtually constant over a relatively long distance or angular range relative to the power takeoff component 8. However, since the load increases further linearly, the result is a somewhat curvate course of the resultant motor load, represented by the curve course 41.

Just before the second extreme position 43 is reached, the pin 20 slips outward again in the recess 19 on the power takeoff component 8, and the spring prestressing of the spring element 21 acts in the opposite direction. This means that in its travel range, the control motor has to brake counter to the spring force exerted by the spring element 21. Until the second extreme position 43 is reached, the braking/motor load then decreases again somewhat, since the load increases further and the spring force decreases somewhat. When current is being supplied to the control motor 1, the system always moves between the first and second extreme positions 42 and 43, respectively.

If the power fails in the second extreme position 43, or after the reversal of the tension direction of the spring element 21, then the spring element 21 pulls the pinion with external teeth, functioning as the power takeoff component 8, into the zone labelled 31, in fact so far that the teeth of the external toothing 10 of the power takeoff component 8 and the teeth 12 of the rack functioning as the adjusting element 11 no longer mesh with one another.

Counter to the remaining worm losses 45, the pinion acting as the power takeoff component 8 rotates still some way farther until it reaches its extreme position; see FIG. 2.4. A chamfer on the end of the rack 11 serves to push it back again partway in the direction of the first extreme position 42, utilizing the residual spring force available, and thus to enable a limited displacement travel during operation without current.

If the current at the control motor 1, conversely, fails in a rotary position of the power take-off component 8 or worm wheel S before the reversal of force of the spring element 21, then the rack acting as the adjusting element 11 automatically moves by means of the load and the spring into the first extreme position 42—an overrotation of the power takeoff component 8 into the zone 31 is not required.

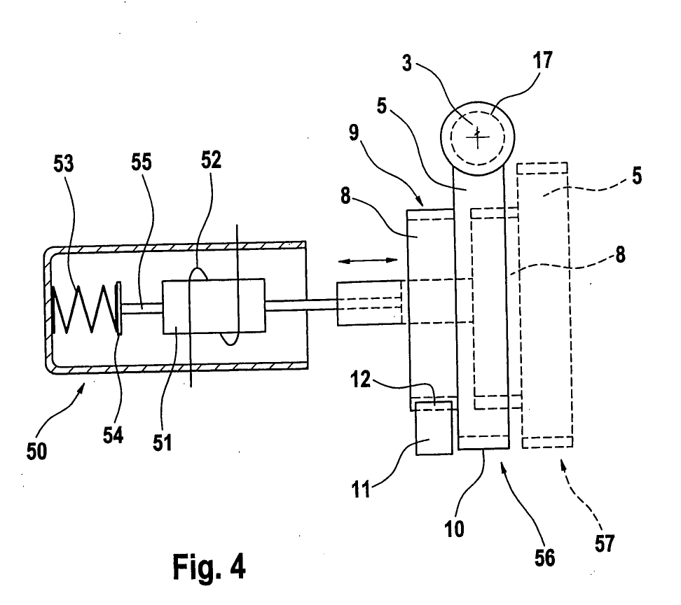

From the view in FIG. 4, the basic layout of an electromagnetic spring system for disconnection in an emergency is shown in further detail, in the states with and without current.

In this illustration, a spring element 53 is kept in the taut state inside an electromagnetically operating valve 50 by a coil 52 through which current flows. The spring prestressing is brought to bear by the iron core 51 that penetrates the coil 52 through which current flows; this core, by means of a rod 55 with a plate attachment 54 provided on it, acts upon the spring element 53 inside the housing of the electromagnetic valve 50. If there is a power failure, the electromagnetic field collapses abruptly, and via the iron core 51, the spring element 53 presses a peg in the horizontal direction as represented by the double arrow. As a result, the engagement position of the worm 3 and worm wheel 5, which is identified by reference numeral 56 and represents the state of the electromagnetic valve 50 with current, can be overcome, by relative displacement of the worm wheel 5. As a result, on the one hand the worm wheel 5 becomes disengaged from the worm 3, and on the other, the external toothing 9 of the power takeoff component 8 becomes disengaged from the teeth 12 of the racklike adjusting element 11. The spring element presses the coaxial assembly comprising the power takeoff component 8 and the worm wheel 5 into the position marked 57, representing the state without current. For displacement of the rack, shown shaded here in FIG. 4 and acting as the adjusting element 11, a further adjusting element would have to be provided that functions when without current.

### LIST OF REFERENCE NUMERALS

1 Actuator drive mechanism
2 Armature shaft
3 Worm
3.1 shaft
4 Line of symmetry
5 Worm wheel
6 Worm wheel axis
7 Direction of rotation
8 Power takeoff component (pinion)
9 External toothing
10 External toothing of worm wheel 5
11 Rack
12 Toothing
13 Pivot point of rack
14 Lever
15 Pivot shaft
16 Pivoting direction
17 Worm thread
18 Direction of rotation
19 Recess
20 Pin
21 Spring element
22 Movable articulation
23 Fixed bearing of spring element
24 Stationary articulation
25 Portion without teeth
26 Actuation stroke
27 Stop
28 Pivoting range
29 Reference stroke
30 Direction of motion of rack
31 Zone
40 Load course
41 Resultant motor load
42 First extreme position (open)
43 Second extreme position (closed)
44 Restoration discontinuity
45 Worm losses
46 Spring force in ,,state without current”
50 Electromagnetic vale
51 Iron core
52 Coil carrying current
53 Spring element
54 Plate attachment
55 Rod
56 State with current
57 State without current
μ_{z} Friction factor
γₘ Lead angle at the penetration of the toothing
D outer diameter
d diameter of the shaft 3.1
dₘ diameter of the worm 3 based on the reference circle
d_{m,w} diameter of the worm wheel 5 based on the reference circle
H tooth height
h height of the flank
l length of the worm 3

1. An actuator drive mechanism with a control motor (1), which on the power takeoff side drives a control gear (3, 5) that includes a final control element (3) on the drive side and a final control element (5) on the power takeoff side, and the final control element (5) on the power takeoff side cooperates with an adjusting element (11), by way of which engines or machine can be varied in their operating behaviour, characterized in that associated with the final control element (3, 5) on the drive side or the power takeoff side is a power takeoff component (8), which includes a force-transmission-free region (25), and on which a spring element (21) is received movably in a recess (19).

2. The actuator drive mechanism of claim 1, wherein the power takeoff component (8) is supported coaxially and rigidly relative to the fmal control element (5) on the power takeoff side.

3. The actuator drive mechanism of claim 1, wherein the power takeoff component (8) is embodied as a pinion with external toothing (9).

4. The actuator drive mechanism of claim 1, wherein the spring element (21) is embodied as a wrap spring.

5. The actuator drive mechanism of claim 1, wherein the recess (19) in the power takeoff component (8) or in the fmal control element (5) on the power takeoff side is embodied as a groove.

6. The actuator drive mechanism of claim 5, wherein a stop of the groove (19) coincides with the rotary axis (3) of the power takeoff component (8) or of the final control element (5) on the power takeoff side.

7. The actuator drive mechanism of claim 5, wherein the spring element (21) is received at its stationary pivot point (24) at a distance from the rotary axis (6) of the power takeoff component (8) or of the final control element (5) on the power takeoff side.

8. The actuator drive mechanism of claim 1, wherein during the rotations of the power takeoff component (8), the spring element (21) assumes its maximum deflection at aproximately a half-revolution of the power takeoff component (8) or of the fmal control element (5) on the power takeoff side.

9. The actuator drive mechanism of claim 8, wherein, if there is a power failure at the control motor (1) before the half-revolution of the power takeoff component (8) is reached, the adjusting element (11) is displaced in the direction of its first extreme position (42) by the load and force of the spring element (21).

10. The actuator drive mechanism of claim 8, wherein, if there is a power failure at the control motor (1) after the completion of the half-revolution of the power takeoff component (8), the power takeoff component (8) is overrotated in the direction of rotation (18), so that the adjusting element (11) and the power takeoff component (8) are disengaged within said force-transmission-free region (25).

11. The actuator drive mechanism of claim 1, wherein the adjusting element (11) is provided with a runup chamfer, which upon contact with the spring element (21) enables a displaceability of the adjusting element (11).

12. The actuator drive mechanism of claim 1, wherein the worm gear (3, 5) is constructed in that way that the average lead angle at the penetration of the toothing γₘ is selected in such a manner that the value of the efficiency η_{z} is greater than 0.5, the efficiency η_{z} is calculated by:
η_{z}=tanγₘ/tan(γₘ+ρ_{z})
with the friction angle ρ_{z}, being a function of the tooth friction factor μ_{z} and being calculated by tan(ρ_{z})=μ_{z}.

13. The actuator drive mechanism of claim 12, wherein the materials of the worm (3) and the worm wheel (5) are selected in such a manner that the friction factor μ_{z} is in the range from 0.01 to 0.2.

14. The actuator drive mechanism of claims 12 or 13, wherein the worm gear (3, 5) includes a lubricant to achieve a friction factor μ_{z} in the range from 0.01 to 0.2.

15. The actuator drive mechanism of claim 1, wherein the ratio of diameter dₘ of the worm 3 to diameter d_{m,w} of the worm wheel 5 based on the reference circle is within the range from 1:3 to 1:7.

16. An actuator drive mechanism with a control motor (1), which on the power takeoff side drives a control gear (3, 5) that includes a final control element (3) on the drive side and a final control element (5) on the power takeoff side, and the final control element (5) on the power takeoff side cooperates with an adjusting element (11), by way of which engines or machines can be varied in their operating behaviour, wherein a coil (52) is associated with a spring element (53) in an electromagnetic valve (50), and the iron core (51) acting as the coil core disengages the final control elements (3, 5) and/or the power takeoff component (8) and adjusting element (11), if there is a power failure at the coil (52).
